(19) United States
(12) Patent Application Publication
(10) Pub. No.: US 2009/0122783 A1
(43) Pub. Date: May 14, 2009

(54) TIME SYNCHRONIZATION METHOD, COMMUNICATION APPARATUS, AND NODE USED FOR THE METHOD

(76) Inventors: Hisaaki Tanaka, Tokyo (JP); Daisuke Ohta, Tokyo (JP)

Correspondence Address: LADAS & PARRY LLP, 224 SOUTH MICHIGAN AVENUE, SUITE 1600, CHICAGO, IL, 60604, US

(21) Appl. No.: 12/092,420

(22) PCT Filed: Nov. 1, 2006
(86) PCT No.: PCT/JP2006/321887

§ 371 Date: May 2, 2008

(30) Foreign Application Priority Data
Nov. 4, 2005 (JP) 2005-320573

(51) Int. Cl. H04J 3/06

(52) U.S. Cl. 370/350

(57) ABSTRACT

A time synchronization method performed by each node in an ad hoc network in which a plurality of nodes are connected with each other by radio and time synchronization of each node is performed by transmitting and receiving a beacon including time information in a beacon period is provided. The time synchronization method includes: a generation step of generating a slot number using a random number every one beacon period; a determination step of determining whether to cancel beacon transmission based on the slot number when the node does not receive a beacon from another node by beacon transmission time corresponding to the slot number; and a step of canceling beacon transmission when determining to cancel beacon transmission in the determination step, and transmitting a beacon including time information of the own node at the beacon transmission time when determining not to cancel beacon transmission.

### TECHNICAL FIELD

The present invention relates to a time synchronization method, and a communication apparatus and a node used for the method. More particularly, the present invention relates to a time synchronization method, and a communication apparatus and a node used for the method in an ad hoc network in which a plurality of nodes are connected by radio with each other, and the nodes transmit and receive a beacon including time information so as to perform time synchronization.

### BACKGROUND ART

In recent years, development is proceeding for the ad hoc network that is formed only by nodes (to be also referred to as terminals), such as a personal computer, a PDA, and a sensor node, that can be connected by radio without necessity of access points.

In an ad hoc network using the IEEE 802.11 protocol (refer to the non-patent document 1), each node updates time included in its inside by sending and receiving a beacon with each other. As a result, after a transient state, times of all nodes agree with each other so that time synchronization is achieved.

FIG. 1 shows a block diagram of an example of an ad hoc network. In the figure, the ad hoc network is formed by a plurality of nodes A-F. More particularly, each of the nodes is a communication device such as a personal computer, a PDA, a sensor node and the like. Each node has a cell of a radius R (communication range) within which the node can perform direct communication. By the way, the radius R has variation to some extent for each node.

Each node includes the following first to third functions in order to synchronize and keep times held by nodes of the ad hoc network shown in FIG. 1 under limited power consumption in an autonomous and decentralized manner.

As shown in FIG. 2, the first function is to repeat two modes that are an active mode and a power save mode with a predetermined period (100 msec, for example). In FIG. 2, a contention window is set in the active mode. The contention window is divided into W+1 (W is 31, for example) backoff slots (one backoff slot is 50 μsec, for example). Each backoff slot is specified by a slot number that is an integer value from 0 to W.

The second function is to perform contention with other nodes during the period of the active mode so that a winning node transmits a beacon including the time of the own node to the surroundings and other nodes do not perform beacon transmission.

The third function is to update the time of the own node into a time included in a received beacon so as to perform time synchronization only when the following conditions 1-3 are satisfied:

(condition 1) The node is in a period of an active mode at that time.

(condition 2) An arriving beacon does not arise collision.

(condition 3) A time included in a received beacon is advanced with respect to a time held by the own node (the time value is larger).

A method for selecting a beacon transmission node in a conventional ad hoc network is described with reference to FIGS. 3A and 3B. Now, assuming that nodes A, B and C exist in a same cell. As shown in FIG. 3A, each of the nodes A, B and C randomly generates a slot number (beacon transmission scheduled time) every beacon period. In this case, assuming that the node C is provided with a smallest slot number (=2), the node A is provided with a slot number (=6), and that the node B is provided with a slot number (=9).

At this time, as shown in FIG. 3B, the node C transmits a beacon at a time corresponding to the slot number (=2), and the nodes A and B receive the beacon. Each of the nodes A and B that received the beacon cancels transmission of a beacon scheduled at each slot number (=6, 9). Accordingly, selection of a beacon transmission node is performed only by contention among nodes.

Non-patent document 1 IEEE Std.802.11 Wireless LAN Medium Access Control (MAC) and Physical Layer (PHY) specification, http://standards.ieee.org/grtieee8o2/download/802.11-1999.pdf

### DISCLOSURE OF THE INVENTION

### Problem to be Solved by the Invention

A problem in the beacon transmission is that collision occurs when a plurality of beacons arrive at a node at a same timing so that any beacon is not received. In this case, time of the node is not updated at the time.

Therefore, if such collision frequently occurs, the transient state continues for a long time until time synchronization completes so that start of normal communication is hindered. In recent researches, the above-mentioned problem is analyzed under conditions that can be actually assumed. As a result, it turned out that the time required until synchronization completes increases in proportion to exponentiation of a number of nodes forming the network, and that a case may occur in which equal to or greater than several tens of seconds are required until synchronization completes using a current transmission rate even in an ad hoc network including about several tens of nodes.

For this reason, in construction of a large-sized ad hoc network based on IEEE 802.11 protocol, there is a problem in that it is difficult to realize a large-sized network including several hundreds or several thousands of nodes in the present state in terms of time synchronization.

The present invention is contrived in view of the above-mentioned point, and an object of the present invention is to provide a technique relating to time synchronization that can obtain high synchronization capability.

### Means for Solving the Problem

The above-mentioned problem can be solved by a time synchronization method performed by each node in an ad hoc network in which a plurality of nodes are connected with each other by radio and time synchronization of each node is performed by transmitting and receiving a beacon including time information in a beacon period, including:

a generation step of generating a slot number using a random number every one beacon period;

a determination step of determining whether to cancel beacon transmission based on the slot number when the node does not receive a beacon from another node by beacon transmission time corresponding to the slot number; and

a step of canceling beacon transmission when determining to cancel beacon transmission in the determination step, and transmitting a beacon including time information of the own node at the beacon transmission time when determining not to cancel beacon transmission.

The time synchronization method may include a step of putting the own node in an active mode for one beacon period after canceling beacon transmission based on the result of the determination in the determination step. Also, the time synchronization method may include a step of putting the own node in an active mode or in a power save mode for one beacon period with an arbitrary probability after canceling beacon transmission based on the result of the determination in the determination step.

The time synchronization method may include a step of putting the own node in an active mode or in a power save mode for one beacon period with a probability based on the slot number after canceling beacon transmission based on the result of the determination in the determination step, and may include a step of putting the own node in an active mode for one beacon period if a time of the own node corresponds to a predetermined time when beacon transmission is canceled.

In addition, the above-mentioned problem can be also solved by a communication apparatus that forms a node in an ad hoc network in which a plurality of nodes are connected with each other by radio and time synchronization of each node is performed by transmitting and receiving a beacon including time information in a beacon period, including:

slot number generation means configured to generate a slot number using a random number every one beacon period;

determination means configured to determine whether to cancel beacon transmission based on the slot number when the communication apparatus does not receive a beacon from another node by beacon transmission time corresponding to the slot number; and

beacon transmission control means configured to cancel beacon transmission when the determination means determines to cancel beacon transmission, and to transmit a beacon including time information of the communication apparatus at the beacon transmission time when the determination means determines not to cancel beacon transmission.

In addition, the present invention can be configured as a program causing a computer, that forms a node in an ad hoc network in which a plurality of nodes are connected with each other by radio and time synchronization of each node is performed by transmitting and receiving a beacon including time information with a beacon period, to function as:

slot number generation means configured to generate a slot number using a random number every one beacon period;

determination means configured to determine whether to cancel beacon transmission based on the slot number when the computer does not receive a beacon from another node by beacon transmission time corresponding to the slot number; and

beacon transmission control means configured to cancel beacon transmission when the determination means determines to cancel beacon transmission, and to transmit a beacon including time information of the computer at the beacon transmission time when the determination means determines not to cancel beacon transmission.

### EFFECT OF THE INVENTION

According to the present invention, useless beacon transmission can be suppressed and occurrence frequency of collision can be reduced so that high synchronization capability can be obtained.

### BRIEF DESCRIPTION OF THE DRAWINGS

FIG. 1 is a block diagram of an example of an ad hoc network;

FIG. 2 is a diagram for explaining beacon period;

FIG. 3A is a diagram for explaining a selection method of a beacon transmission node in a conventional ad hoc network;

FIG. 3B is a diagram for explaining a selection method of a beacon transmission node in a conventional ad hoc network;

FIG. 4 is a block diagram of an embodiment of a node forming an ad hoc network of the present invention;

FIG. 5 is a flowchart of a first embodiment of beacon transmitting and receiving processes;

FIG. 6A is a diagram for explaining a selection method of a beacon transmission node in an ad hoc network of the present invention;

FIG. 6B is a diagram for explaining a selection method of a beacon transmission node in an ad hoc network of the present invention;

FIG. 7 is a flowchart of a second embodiment of beacon transmitting and receiving processes;

FIG. 8 is a flowchart of a third embodiment of beacon transmitting and receiving processes;

FIG. 9 is a flowchart of a fourth embodiment of beacon transmitting and receiving processes;

FIG. 10 is a diagram for explaining time synchronization in an ad hoc network of the present invention; and

FIG. 11 is a diagram for explaining time synchronization in an ad hoc network of the present invention.

### DESCRIPTION OF REFERENCE SIGNS

10 hard disk device
11 CPU
12 memory
13 input device
14 display device
15 PC card slot
16 bus
20 radio network card
21 interface unit
22 processor unit
23 MAC processing unit
24 modulation and demodulation unit
25 transmitting and receiving unit
26 antenna

### PREFERRED EMBODIMENTS FOR CARRYING OUT THE INVENTION

In the following, embodiments of the present invention is described based on the figures.

<Configuration of Node Apparatus>

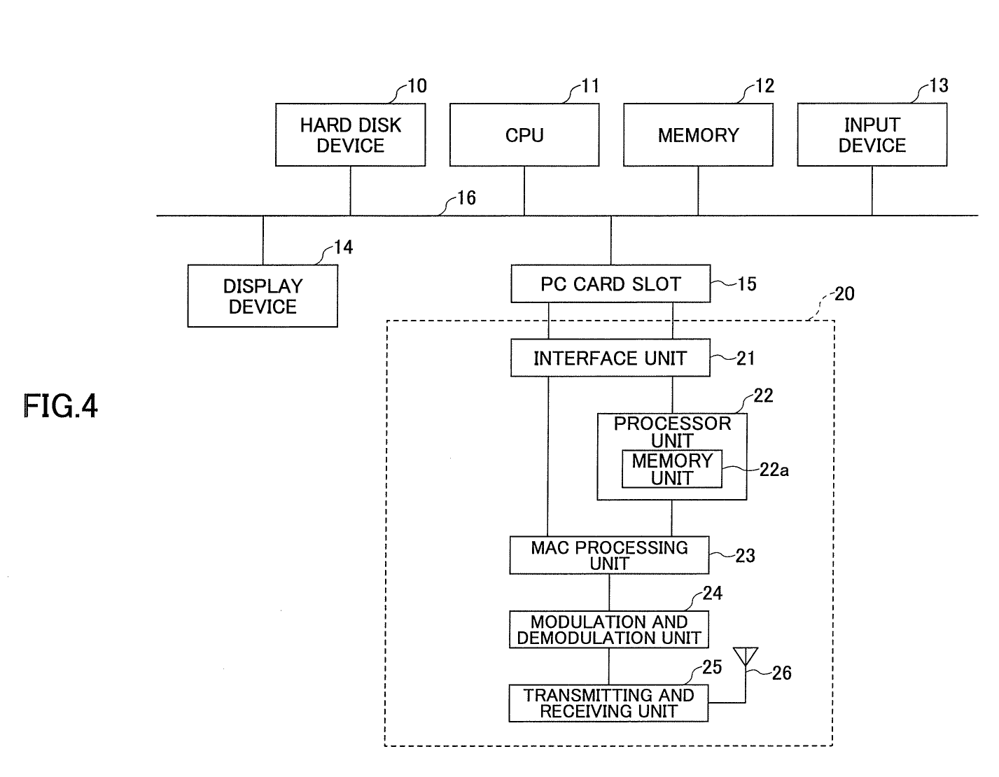

FIG. 4 shows a block diagram of an embodiment of a node forming an ad hoc network of the present invention. This node is a personal computer, and a hard disk device 10 stores various programs executed by a CPU 11 and data and the like. When the CPU 11 executes a program read from the hard disk device 10, the CPU 11 uses a memory 12 as a working area. An input device 13 is a pointing device such as a key board, a mouse and the like. A display device 14 performs display. Units from the hard disk device 10 to a PC card slot 15 are connected with each other by a bus 16. A radio network card 20 as a communication apparatus is mounted to the PC card slot 15, and the PC card slot 15 is connected to the bus 16.

The radio network card 20 includes an interface unit 21, a processor unit 22, a MAC processing unit 23, a modulation and demodulation unit 24, a transmitting and receiving unit 25, and an antenna 26. The interface unit 21 connects the processor unit 22 and the MAC (Media Access Control) processing unit 23 to the bus 16.

The processor unit 22 controls the MAC processing unit 23 to cause it to perform MAC processing, and performs after-mentioned beacon transmitting and receiving processes. The processor unit 22 includes a memory unit 22a in its inside for performing the beacon transmitting and receiving processes.

By the way, instead of the processor unit 22 and the memory unit 22a, the radio network card may be provided with a configuration of a computer including a CPU and a memory storing a program. In this case, the CPU executes the program stored in the memory so that processes similar to after-mentioned processes performed by the processor unit 22 are performed. In addition, a computer such as a terminal forming a node may execute the program so as to perform the processes similar to the processes performed by the processor unit 22.

The program may be stored into the memory from an external recording medium (transportable memory and the like), or the program may be downloaded via a network. By the way, in the case when the CPU and the memory storing the program are provided instead of the processor unit 22 and the memory unit 22a, the radio network card 20 itself can be called a computer.

The MAC processing unit 23 executes MAC (media access control) processes defined in IEEE 802.11. The modulation and demodulation unit 24 performs modulation and demodulation based on DSSB (Direct Sequence Spread Spectrum), CCK (Complementary Code Keying) or OFDM (Orthogonal Frequency Division Multiplexing) modulation scheme. The transmitting and receiving unit 25 performs transmitting and receiving using the antenna 26.

### First Embodiment

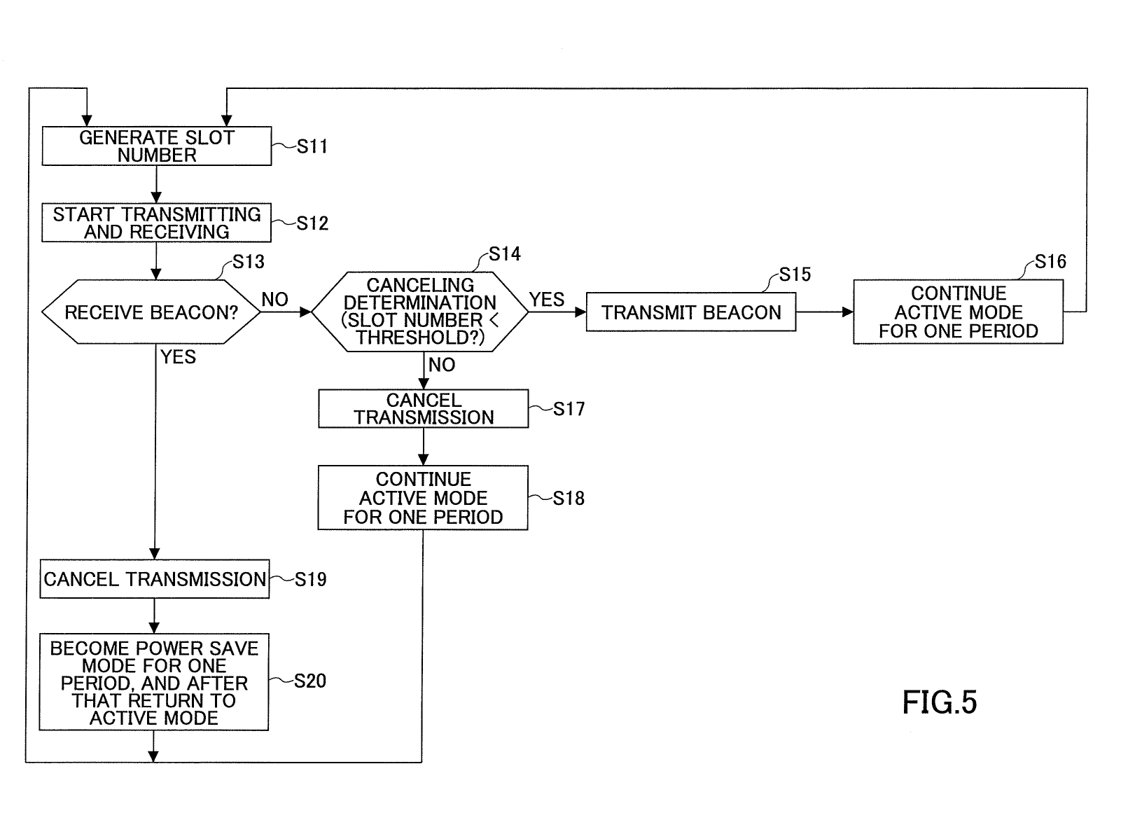

FIG. 5 shows a flowchart of a first embodiment of beacon transmitting and receiving processes performed by the processor unit 22 of the radio network card 20 mounted in a node forming the ad hoc network. In the figure, the processor unit 22 generates a slot number that is a value from 0 to 31 using a random number and the like in step S11 that is executed every one beacon period so as to start transmitting and receiving in step S12.

In step S13, the processor unit 22 determines whether the node receives a beacon from another node without occurrence of collision by the time for transmitting a beacon. When the node does not receive the beacon, the process goes to step S14, so that the processor unit 22 performs canceling (cutting) determination of beacon transmission. In the canceling determination, the processor unit 22 performs determination whether the slot number generated in step S11 is smaller than a threshold (1, for example) set in the memory unit 22a beforehand. When the slot number is smaller than the threshold, canceling is avoided. When the slot number is equal to or greater than the threshold, canceling is performed.

When canceling of beacon transmission is avoided, the node transmits a beacon including a time of the own node in step S15, and the node continues the active mode for one beacon period in step S16, and the process goes to step S11. When canceling is performed, the node cancels beacon transmission in step S17, and the node continues the active mode for one beacon period in step S18, and the process goes to step S11.

On the other hand, when the node receives a beacon in step S13, the node cancels beacon transmission in step S19, and the node enters in a power save mode for one beacon period in step S20. After that, the node returns to an active mode so that the process goes to step S11.

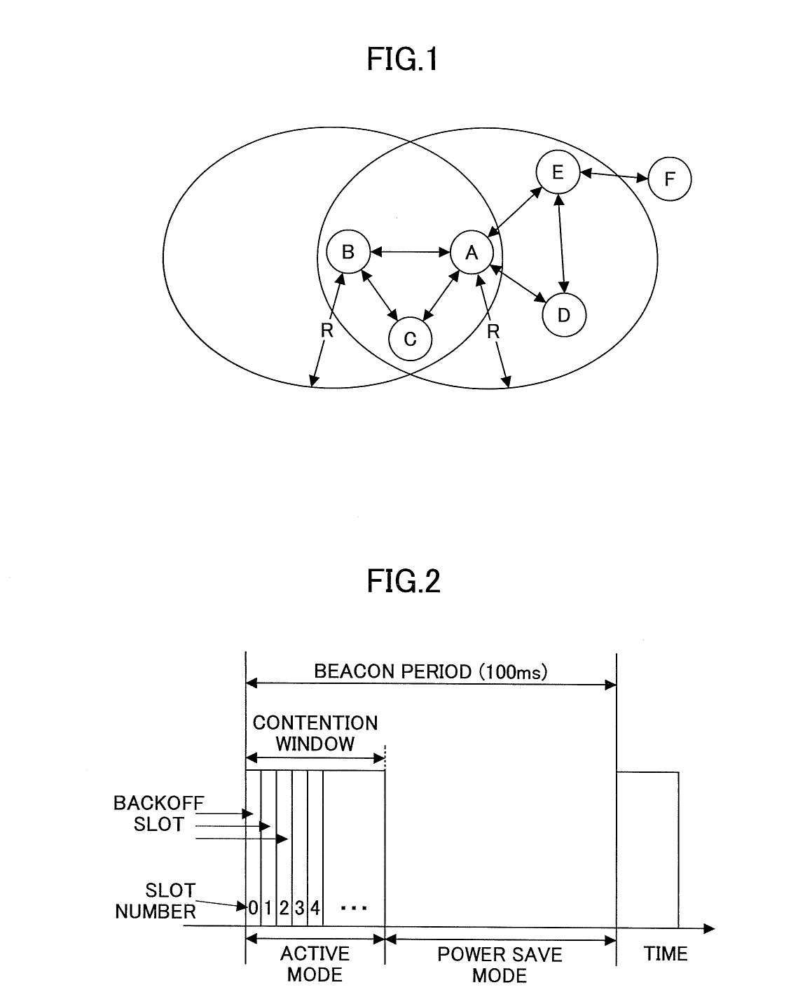

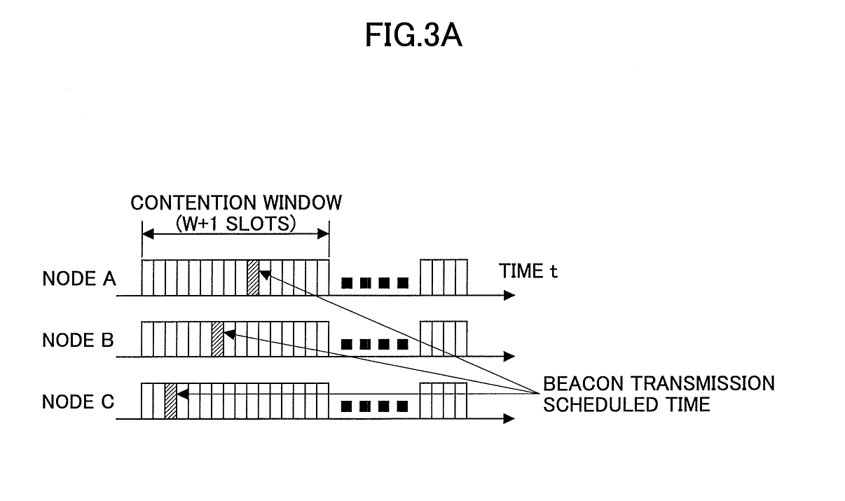

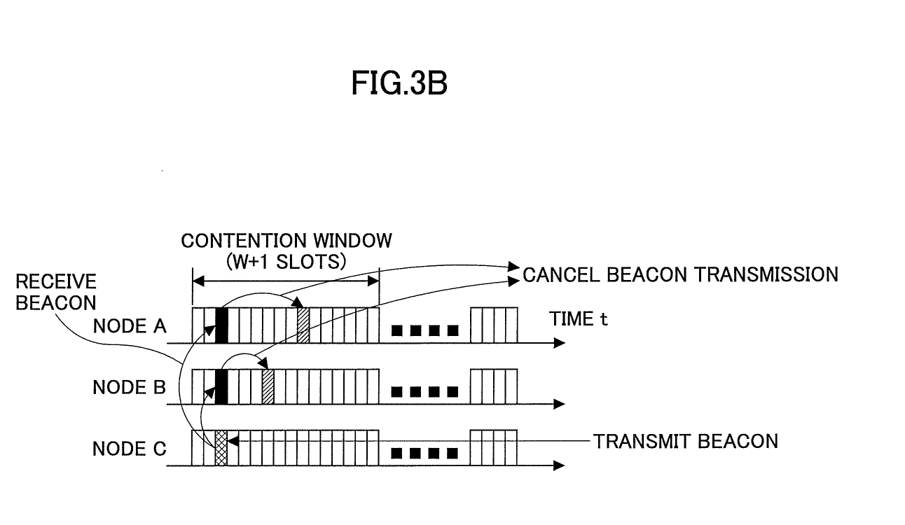

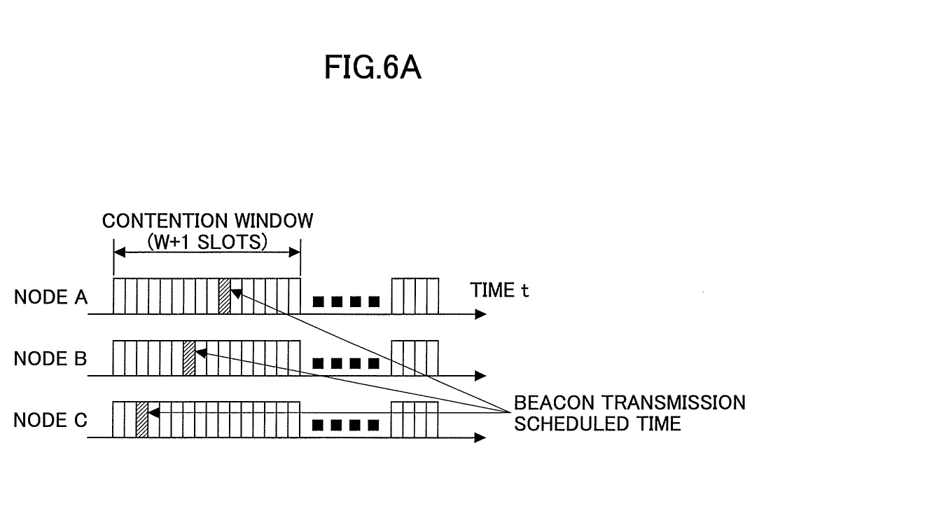

A method for selecting a beacon transmission node in the ad hoc network of the present embodiment is described with reference to FIGS. 6A and 6B. As shown in FIG. 1, it is assumed that the nodes A, B and C exist in a same cell. As shown in FIG. 6A, each of the nodes A, B and C randomly generates a slot number (beacon transmission scheduled time) every beacon period. In this case, it is assumed that the node C is provided with a smallest slot number (=2), the node A is provided with a slot number (=6), and that the node B is provided with a slot number (=9).

At this time, after contention among the nodes A, B and C, the node C having the smallest slot number is selected as a beacon transmission node from among the nodes in the cell. That is, among the nodes A, B and C, a node that becomes a beacon transmission time at the earliest time before receiving a beacon from other node is the node C.

Before transmitting a beacon, the node C checks whether the slot number exceeds a threshold (1, for example) (FIG. 6B). When the slot number is smaller than the threshold (that is, when the slot number is 0), the node C transmits a beacon as scheduled, and the node C continues the active mode after that. On the other hand, when the slot number is equal to or greater than the threshold, the node C does not transmit a beacon, and at the same time, the node C continues the active mode as originally scheduled. The above-mentioned additional operation is called canceling determination of beacon transmission based on threshold.

In the present embodiment, the number of nodes selected as beacon transmission nodes can be decreased by performing canceling of the beacon transmission, so that collision occurrence frequency can be decreased. Therefore, a time until time synchronization completes can be decreased so that high synchronization capability can be obtained.

### Second Embodiment

In the first embodiment, a node that stops originally scheduled beacon transmission based on canceling determination automatically continues the active mode after that. However, as a number of nodes that perform canceling increases, a number of nodes that continues the active mode increases. Thus, energy consumption in the whole nodes of the ad hoc network increases. Therefore, second and third embodiments contrived in view of suppressing energy consumption of nodes are described.

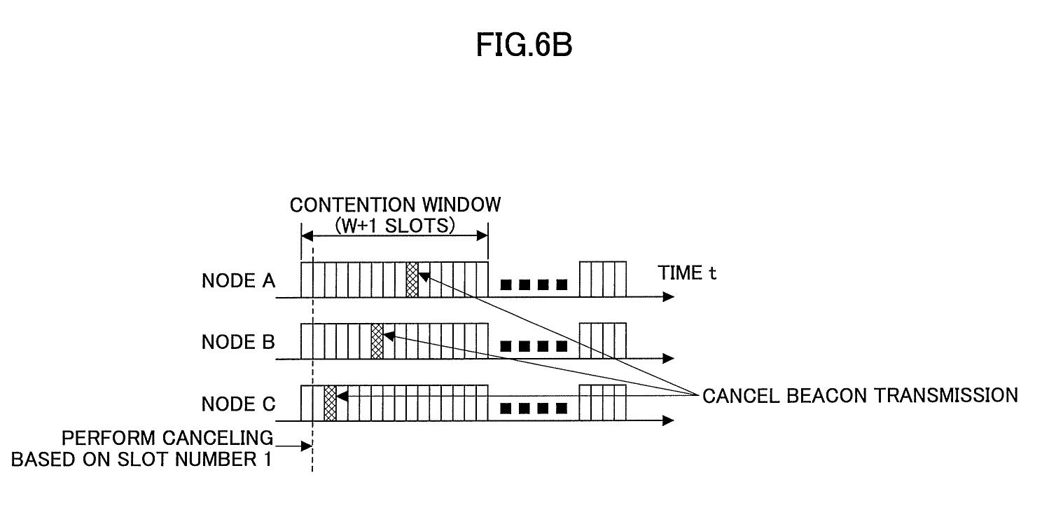

FIG. 7 shows a flowchart of the second embodiment of the beacon transmitting and receiving method performed by the processor unit 22 of the radio network card 20 mounted in a node forming the ad hoc network. In the figure, the processor unit 22 generate a slot number that is a value from 0-31 using a random number and the like in step S31 executed every one beacon period, and transmission and reception are started in step S32.

In step S33, the processor unit 22 determines whether it receives a beacon from another node without collision by the time for transmitting a beacon. When the node does not receive the beacon, the process goes to step S34, so that the processor unit 22 performs canceling determination for beacon transmission. In the canceling determination, it is determined whether the slot number generated in step S31 is smaller than a threshold (1, for example) set in the memory unit 22a beforehand. When the slot number is smaller than the threshold, canceling is avoided. When the slot number is equal to or greater than the threshold, canceling is performed.

When canceling of beacon transmission is avoided, the node transmits a beacon including a time of the own node in step S35, and the node continues the active mode for one beacon period in step S36, and the process goes to step S31. When it is determined to perform canceling, the node cancels beacon transmission in step S37, and the node selects an active mode with a predetermined probability (90%, for example) using a random number in step S38, and selects a power save mode with the remaining probability (10%, for example), and continues the selected mode for one beacon period. After that, the node returns to the active mode, and the process goes to step S31.

On the other hand, when the node receives a beacon in step S33, the node cancels beacon transmission in step S39, and the node enters in a power save mode for one beacon period in step S40. After that, the node returns to an active mode so that the process goes to step S31.

Accordingly, increase of energy consumption in the whole nodes of the ad hoc network can be reduced.

### Third Embodiment

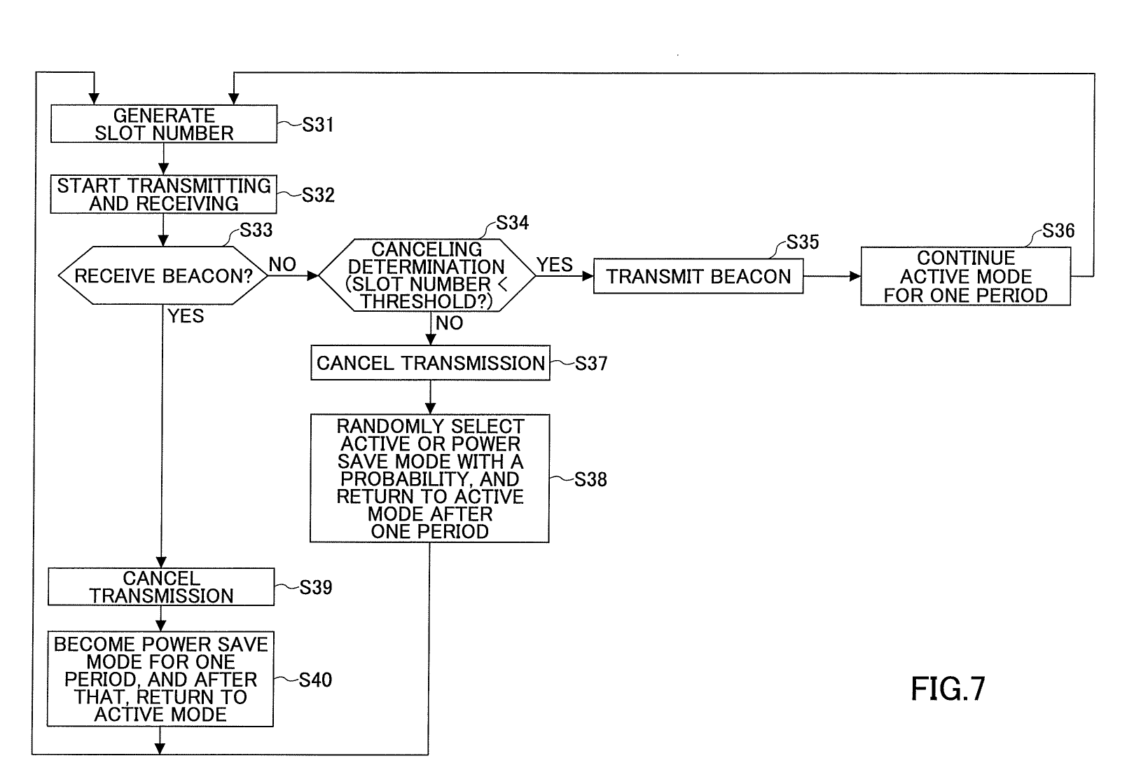

FIG. 8 shows a flowchart of the third embodiment of the beacon transmitting and receiving method performed by the processor unit 22 of the radio network card 20 mounted in a node forming the ad hoc network. In the figure, the processor unit 22 generate a slot number that is a value from 0-31 using a random number and the like in step S51 executed every one beacon period, and transmission and reception are started in step S52.

In step S53, the processor unit 22 determines whether it receives a beacon from other node without collision by the time for transmitting a beacon. When the node does not receive the beacon, the process goes to step S54, so that the processor unit 22 performs canceling determination for beacon transmission. In the canceling determination, it is determined whether the slot number generated in step S51 is smaller than a threshold (1, for example) set in the memory unit 22a beforehand. When the slot number is smaller than the threshold, canceling is avoided. When the slot number is equal to or greater than the threshold, canceling is performed.

When canceling of beacon transmission is avoided, the node transmits a beacon including a time of the own node in step S55, and the node continues the active mode for one beacon period in step S56, and the process goes to step S51. When canceling is performed, the node cancels beacon transmission in step S57, and the node determines whether the slot number is equal to or less than a predetermine value (30, for example) set in the memory unit 22a beforehand in step S58. When the slot number is equal to or less than the predetermined value, the process goes to step S56, and the node continues the active mode for one beacon period, then the process goes to step S51. When the slot number exceeds the predetermined value, the process goes to step S59, and the node enters in a power save mode for one beacon period. After that, the node returns to an active mode, and the process goes to step S51.

On the other hand, when the node receives a beacon in step S53, the node cancels beacon transmission in step S60, and the node enters in a power save mode for one beacon period in step S61. After that, the node returns to an active mode so that the process goes to step S51.

In the above-mentioned second embodiment, the node selects between the active mode or the power save mode using a random number when transmission canceling is performed based on the canceling determination result. On the other hand, the node selects between the active mode or the power save mode using the slot number originally generated by a random number. The results are substantially the same.

### Fourth Embodiment

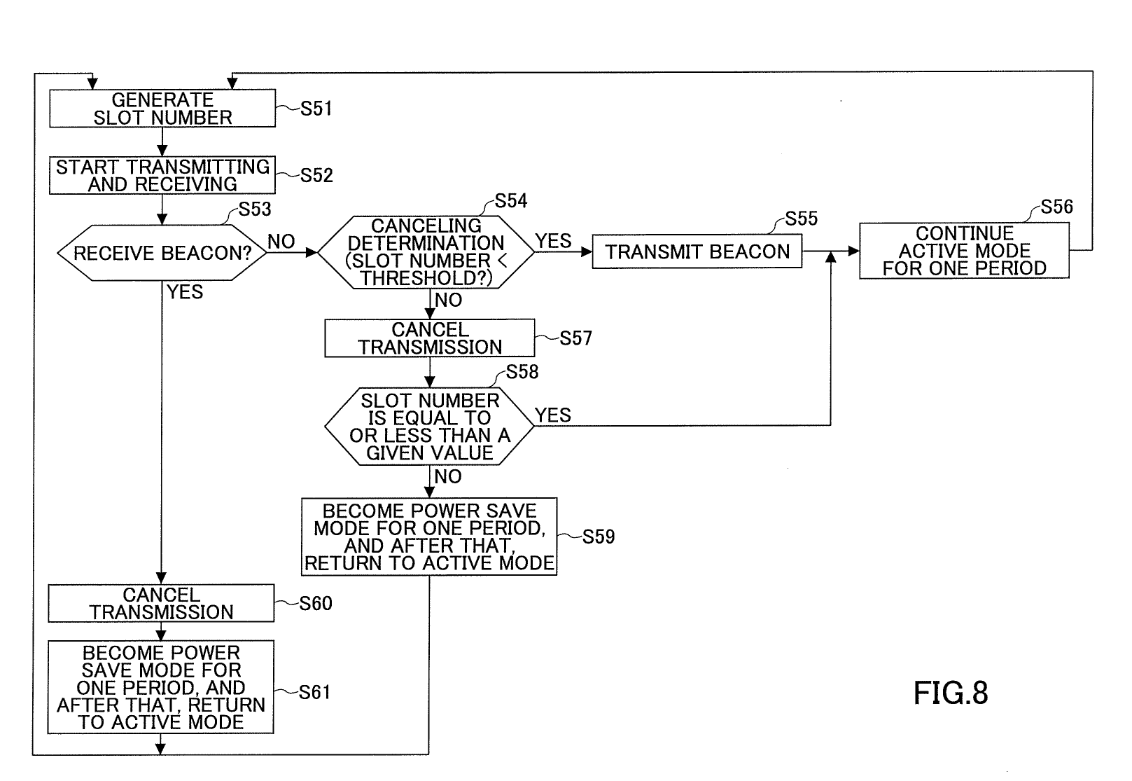

FIG. 9 shows a flowchart of the fourth embodiment of beacon transmitting and receiving method performed by the processor unit 22 of the radio network card 20 mounted in a node forming the ad hoc network. In the figure, the processor unit 22 generate a slot number that is a value from 0-31 using a random number and the like in step S71 executed every one beacon period, and transmission and reception are started in step S72.

In step S73, the processor unit 22 determines whether it receives a beacon from another node without collision by a time for transmitting a beacon. When the node does not receive the beacon, the process goes to step S74, so that the processor unit 22 performs canceling determination for beacon transmission. In the canceling determination, it is determined whether the slot number generated in step S71 is smaller than a threshold (1, for example) set in the memory unit 22a beforehand. When the slot number is smaller than the threshold, canceling is avoided. When the slot number is equal to or greater than the threshold, canceling is performed.

When canceling of beacon transmission is avoided, the node transmits a beacon including a time of the own node in step S75, and the node continues the active mode for one beacon period in step S76, and the process goes to step S71. When canceling is performed, after the node cancels beacon transmission in step S77, the process goes to step S80.

On the other hand, when the node receives a beacon in step S73, after the node cancels beacon transmission in step S79, the process goes to step S80. In step S80, the processor unit 22 determines whether the time of the node is a predetermined time (time which corresponds to an integer second, for example) set in the memory unit 22a beforehand. When the time of the node corresponds to the predetermined time, the node continues the active mode for one beacon period in step S81, so that the process goes to step S71. When the time of the node is not the predetermined time, the node enters in a power save mode for one beacon period in step S82, and after that, the node returns to an active mode and goes to step S71.

Accordingly, each node continues the active mode for one beacon period for each time when the time held within the inside of the node becomes an integer second, and each node receives a beacon transmitted from a beacon transmission node during the active mode, so that time synchronization is performed in unison.

By the way, it is needless to say that steps S80-S82 of FIG. 9 may be added in the embodiments shown in FIGS. 7 and 8.

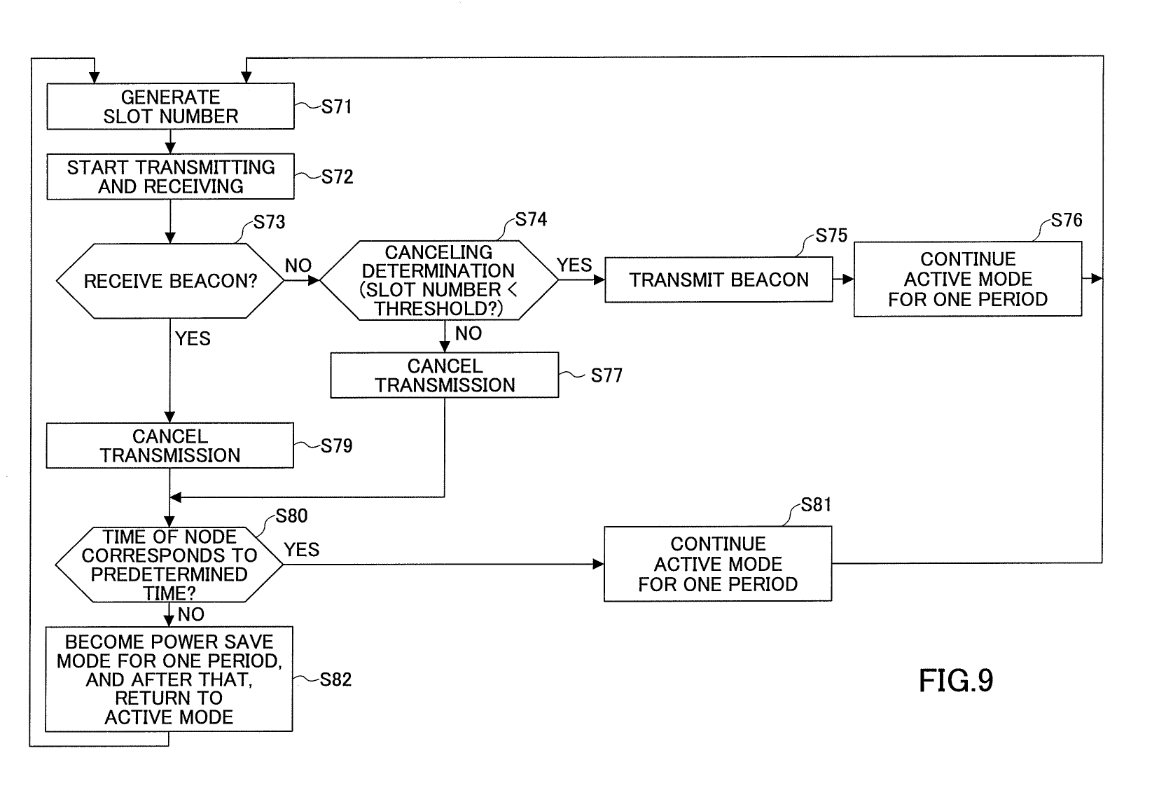

FIG. 10 assumes a case in which 36 nodes are fixedly placed at random in a square area AR1, 5R on a side. By the way, R is a normalized distance corresponding to a radius of a communication range. It is assumed that each node has a communication range R uniformly. In this example, initially, it is assumed that each node in the area AR1 transmits and receives beacons with each other so that the whole time synchronization is obtained and one ad hoc network (before-mentioned network) is formed.

At this time, it is assumed that a node ND1 that belonged to another network quickly enters into a position in the area AR1. In this example, it is assumed that the time held by the node ND1 is advanced compared with times held by nodes forming the network (that is, the value is greater), and that the phase of the active mode in beacon period in the node ND1 is almost reverse with respect to the phase in the active mode in beacon period of the network.

In this example, the entered node ND1 synchronizes times of nodes in the active mode that exist in the communication range R. Since propagation of the time synchronization is performed via a small number of nodes that continue the active mode within the communication range R, the propagation is performed with a slow timescale of an order of a beacon period (100 ms).

When using a conventional ad hoc network, it is recognized that propagation of time synchronization quickly progresses along the border of the area AR1 in a direction of an outline arrow in a first stage, after that, in a second stage, nodes that are remained in the inside of the area AR1 gradually synchronizes taking a long time.

The reason of occurrence of the first stage is as follows. A node having a smallest slot number as a result of random slot number generation is determined as a node (beacon transmission node) taking the role of time propagation. At this time, since there is no node outside of the area AR1 near the border of the area AR1, relative node density becomes sparse so that a node near the border is selected as the beacon transmission node relatively frequently. In FIG. 10, nodes having the advanced time are shown by white circles and nodes having delayed time are indicated by black circles in the second stage.

On the other hand, according to the present invention, although propagation of time synchronization in the process of the first stage becomes faster than the conventional technique, it is not so large difference. However, synchronization process different from the conventional technique is exhibited in the second stage. The characteristic is that a node at the center part of the area AR1 repeats between a time in which synchronization does not progress very much and a time, in contrast, in which synchronization progresses abruptly. As a result, compared with the conventional technique, time required for completing the whole synchronization is largely decreased. The reason is described based on the following mechanism.

(A) Since nodes at the border part of the area AR1 suffer canceling of beacon transmission based on canceling determination, occurrence rate of collision of beacon becomes low in nodes at the center part of the area AR1.

(B) A case in which effects of transmission canceling strongly appear frequently occurs, so that there occurs a case in which almost all of nodes at the border part of the area AR1 suffer transmission canceling in a beacon period when the effects of canceling strongly appear. In this case, beacons do not come to nodes at the center part from nodes at the border part of the area AR1, so that synchronization does not progress at that time.

(C) In nodes, in which synchronization has not been achieved, located at the center part of the area AR1, transmission canceling based on canceling determination cannot be avoided when generating the slot number so that a case sometimes occurs in which all nodes suffer the canceling.

(D) Right after (C) occurs, all nodes located at the center part that have not achieved synchronization are in an active mode. Thus, like the case of (A), when beacons come from nodes at the border part of the area AR1 without collision, all nodes located at the center part of the area AR1 complete synchronization at a burst.

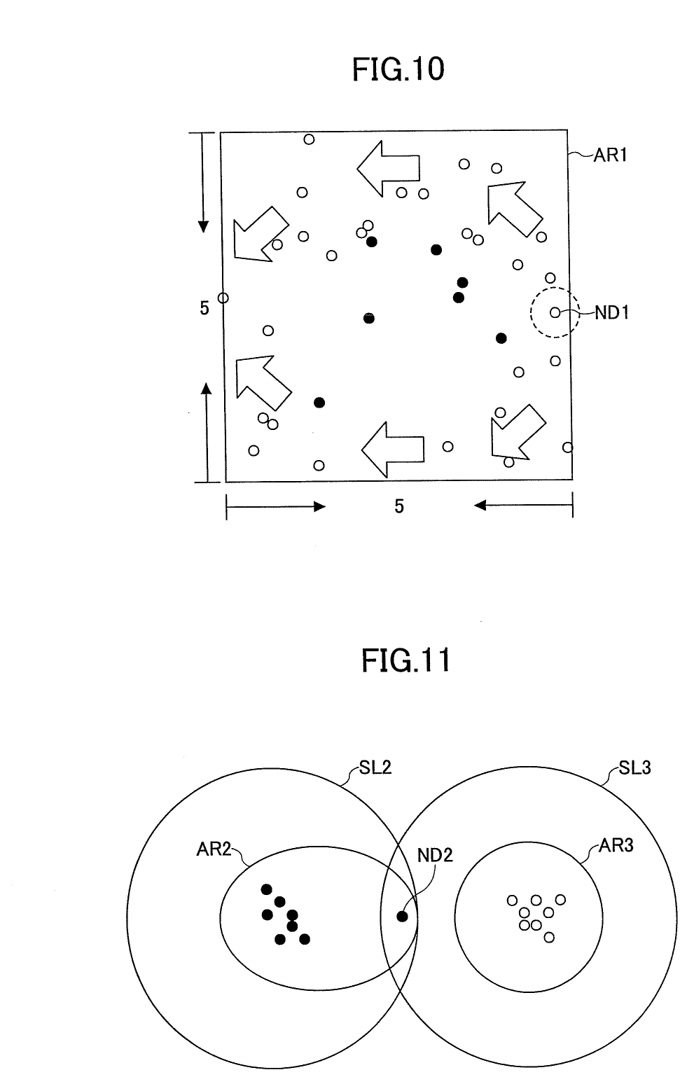

Although FIG. 10 is an example in which spatial spread of the network is considered, large time reduction for time synchronization can be recognized based on the similar mechanism also in a case of densely placed node arrangement as shown in FIG. 11.

In FIG. 11, a plurality of nodes each shown as a black circle exist in an area AR2, and a plurality of nodes each shown as a white circle exist in an area AR3. A part of a cell SL2 in which the black circle nodes can directly communicate with each other overlaps a part of a cell SL3 in which the white circle nodes can directly communicate with each other, and a node ND2 of the black circle is placed in the overlapping part. In addition, it is assumed that the time of the while circle nodes is advanced compared with that of the black circle nodes, and that the phase of the active mode in a beacon period is almost reverse between the black circle nodes and the white circle nodes.

Also in this case, when the node ND2 of the black circle continues the active mode for one beacon period after canceling beacon transmission or after transmitting a beacon, the node ND2 quickly performs time synchronization by receiving a beacon from a white circle node. After that, in the same way, due to beacon transmission from the node ND2, the black circle nodes in the area AR2 sequentially perform time synchronization. Accordingly, time required for time synchronization can be largely reduced compared with the conventional technique.

The above-mentioned mechanisms of (C) and (D) largely contribute to the time reduction for time synchronization in the first to third embodiments of the present invention. In (C) and (D), a state in which all nodes that have not achieved synchronization become active occurs stochastically, and, in the fourth embodiment, since the state in which all nodes that have not achieved synchronization become active occurs every predetermined time at a constant frequency, time required for synchronization can be further reduced.

As to consumption energy, it is necessary to consider a first consumption energy required for packet transmission and for continuing active mode in each node at the transition state in which synchronization is progressing, and a second consumption energy required for packet transmission and for continuing active mode in each node at a stationary state after completion of synchronization.

In the first embodiment of the present invention, as to the first consumption energy, consumption energy per a unit time becomes a little higher than the conventional technique. However, since a continuing time of the transient state becomes largely shorter compared with the conventional technique, the total sum of the first consumption energy of the present invention is eventually lower than that of the conventional technique. On the other hand, as to the second consumption energy, significant difference cannot be found between the conventional technique and the present invention except when the communication range R is very small. Therefore, as to all consumption energy, it can be recognized that the present invention has higher energy saving effect compared with the conventional technique. In addition, these tendencies can be strengthened by introducing the second and third embodiments.

The present invention is not limited to the specifically disclosed embodiments, and variations and modifications may be made within the scope of the claims.

The present international application claims priority based on Japanese patent application No. 2005-320573, filed in the JPO on Nov. 4, 2005 and the entire contents of the Japanese patent application is incorporated herein by reference.

1. A time synchronization method performed by each node in an ad hoc network in which a plurality of nodes are connected with each other by radio and time synchronization of each node is performed by transmitting and receiving a beacon including time information in a beacon period, comprising:
a generation step of generating a slot number using a random number every one beacon period;
a determination step of determining whether to cancel beacon transmission based on the slot number when the node does not receive a beacon from another node by beacon transmission time corresponding to the slot number; and
a step of canceling beacon transmission when determining to cancel beacon transmission in the determination step, and transmitting a beacon including time information of the own node at the beacon transmission time when determining not to cancel beacon transmission.

2. The time synchronization method as claimed in claim 1, comprising:
a step of putting the own node in an active mode for one beacon period after canceling beacon transmission based on the result of the determination in the determination step.

3. The time synchronization method as claimed in claim 1, comprising:
a step of putting the own node in an active mode or in a power save mode for one beacon period with an arbitrary probability after canceling beacon transmission based on the result of the determination in the determination step.

4. The time synchronization method as claimed in claim 1, comprising:
a step of putting the own node in an active mode or in a power save mode for one beacon period with a probability based on the slot number after canceling beacon transmission based on the result of the determination in the determination step.

5. The time synchronization method as claimed in any one of claims 1-4, comprising:
a step of putting the own node in an active mode for one beacon period if a time of the own node corresponds to a predetermined time when beacon transmission is canceled.

6. A communication apparatus that forms a node in an ad hoc network in which a plurality of nodes are connected with each other by radio and time synchronization of each node is performed by transmitting and receiving a beacon including time information in a beacon period, comprising:
slot number generation means configured to generate a slot number using a random number every one beacon period;
determination means configured to determine whether to cancel beacon transmission based on the slot number when the communication apparatus does not receive a beacon from another node by beacon transmission time corresponding to the slot number; and
beacon transmission control means configured to cancel beacon transmission when the determination means determines to cancel beacon transmission, and to transmit a beacon including time information of the communication apparatus at the beacon transmission time when the determination means determines not to cancel beacon transmission.

7. The communication apparatus as claimed in claim 6, comprising:
active mode setting means configured to put the communication apparatus in an active mode for one beacon period if a time of the communication apparatus corresponds to a predetermined time when beacon transmission is canceled.

8. A node comprising the communication apparatus as claimed in claim 6 or 7.

9. A program causing a computer, that forms a node in an ad hoc network in which a plurality of nodes are connected with each other by radio and time synchronization of each node is performed by transmitting and receiving a beacon including time information with a beacon period, to function as:
slot number generation means configured to generate a slot number using a random number every one beacon period;
determination means configured to determine whether to cancel beacon transmission based on the slot number when the computer does not receive a beacon from another node by beacon transmission time corresponding to the slot number; and
beacon transmission control means configured to cancel beacon transmission when the determination means determines to cancel beacon transmission, and to transmit a beacon including time information of the computer at the beacon transmission time when the determination means determines not to cancel beacon transmission.

10. The program as claimed in claim 9, further causing the computer to function as:
active mode setting means configured to put the computer in an active mode for one beacon period if a time of the computer corresponds to a predetermined time when beacon transmission is canceled.

11. A computer readable recording medium storing the program as claimed in claim 9 or 10.
